(19) United States
(12) Patent Application Publication
(10) Pub. No.: US 2025/0266526 A1
(43) Pub. Date: Aug. 21, 2025

(54) HOUSING ELEMENT OF A BATTERY AND BATTERY COMPRISING SUCH A HOUSING ELEMENT

(71) Applicant: Robert Bosch GmbH, Stuttgart (DE)

(72) Inventor: Markus Schmitt, Tamm (DE)

(21) Appl. No.: 18/858,392

(22) PCT Filed: Apr. 26, 2023
(86) PCT No.: PCT/EP2023/060922

§ 371 Date: Oct. 21, 2024

(30) Foreign Application Priority Data
May 3, 2022 (DE) 10 2022 204 342.1

(51) Int. Cl. H01M 10/6556; H01M 10/42

(52) U.S. Cl. CPC H01M 10/6556; H01M 10/425; H01M 2010/4271

(57) ABSTRACT

The invention relates to a housing element of a battery (1), wherein the housing element (2) is designed to be connected to an additional housing element (3), said elements providing a commonly formed interior space (4) for accommodating a plurality of battery cells (20), wherein the housing element (2) forms a first temperature-control structure (51), and a cover element (6) that forms a second temperature-control structure (52) is connected to the housing element (2) such that a flow chamber (5), through which temperature-control fluid (7) can flow, is delimited in a fluid-tight manner, wherein the first temperature-control structure (51) and the second temperature-control structure (52) are arranged inside the flow chamber (5) and are arranged so that temperature-control fluid (7) can flow around them, wherein a first element (81) of a battery controller is arranged in a thermally conductive manner on the housing element (2), and a second element (82) of a battery controller is arranged in a thermally conductive manner on the cover element (6), wherein the flow chamber (5) comprises a plurality of regions (9), whereby the first temperature-control structure (51) and the second temperature-control structure (52) each have a different design.

### BACKGROUND

The invention is based on a housing element of a battery. The object of the present invention is also a battery comprising such a housing element.

Provided is a battery module comprising a plurality of individual battery cells, each of which has a positive voltage tap and a negative voltage tap, whereby the respective voltage taps are connected to each other in an electrically conductive manner for an electrically conductive serial and/or parallel connection of the plurality of battery cells to each other and can thus be interconnected to form the battery module. In particular, the battery cells can each have a first voltage tap, in particular a positive voltage tap, and a second voltage tap, in particular a negative voltage tap, which are connected to each other in an electrically conductive manner by means of cell connectors so that an electrically serial and/or parallel connection is formed. Battery modules are themselves in turn interconnected into batteries or entire battery systems.

Due to chemical conversion processes, the interiors of lithium-ion battery cells or lithium polymer battery cells heat up, primarily during rapid energy delivery or absorption in battery systems. The more powerful the battery system is, the greater its heating, thus resulting in the need for an efficient active thermal management system.

The prior art is, for example, publication DE 10 2018 220 937 as well as unpublished publication DE 10 2021 200 040, each of which describes a housing element of a battery, which serves to temperature-control a plurality of battery cells.

Publication DE 10 2019 214 199 is also part of the prior art for this purpose and discloses a battery having two cooling planes. In particular, the two cooling planes are fluidically connected by means of a connecting piece, so that common temperature control is enabled. A supply for the temperature-control process is, e.g., possible via connector nozzles to a vehicle interface, and thus to the cooling circuit of the vehicle.

### SUMMARY

A housing element of a battery having the features of the independent claim offers the advantage that optimized temperature control of a battery controller, in particular of a first element of a battery controller and a second element of a battery controller, can be provided. In particular, the temperature control can be optimized with regard to the pressure drop of the coolant, the heat transmission, and the deaerability of a flow chamber.

According to the invention, a housing element of a battery is provided for this purpose. The housing element is in this case designed to be connected to an additional housing element, said elements together providing a commonly formed interior space. A plurality of battery cells can be accommodated within this interior space. The housing element thereby forms a first temperature-control structure. Furthermore, a cover element is connected to the housing element such that a flow chamber is delimited, through which the temperature-control fluid can flow. The cover element thereby forms a second temperature-control structure. The first temperature-control structure and the second temperature-control structure are arranged inside the flow chamber. Furthermore, the first temperature-control structure and the second temperature-control structure are arranged so that the temperature-control fluid can flow around them. A first element of a battery controller is arranged in a thermally conductive manner on the housing element and a second element of a battery controller is arranged in a thermally conductive manner on the cover element. According to the invention, the flow chamber comprises a plurality of regions, whereby the first temperature-control structure and/or the second temperature-control structure each have a different design.

It is advantageous for the first element of a battery controller to be arranged directly adjacent to the first temperature-control structure, and for the second element of a battery controller to be arranged directly adjacent to the second temperature-control structure. As a result, particularly reliable and optimized heat transmission can be provided.

In particular, the first element of a battery controller is arranged on a side of the housing element facing away from the cover element and, in particular, the second element of a battery controller is arranged on a side of the cover element facing the interior space. In other words, a temperature-control plane is, e.g., formed on a top side of the housing element and on a bottom side of the cover element. The first element of a battery controller can, e.g., be arranged on this upper side, and the second element of a battery controller can, e.g., be arranged on this lower side.

In addition, a thermal compensation material can preferably be arranged to improve the thermal connection of the first element of a battery controller to the housing element and of the second element of the battery controller to the cover element, which is arranged in particular between the first element of a battery controller and the housing element and between the second element of a battery controller and the cover element. Preferably, such a thermal compensation material can be what is referred to as a gap pad, a gap filler, or an adhesive designed to be thermally conductive.

It is advantageous for the first element of a battery controller to be an electrical voltage converter, in particular a DC/DC voltage converter, and/or for the second element of a battery controller to be an overcurrent protection device.

A DC/DC voltage converter is used in order to convert a DC/DC voltage supplied to an input into a regulated or unregulated DC voltage, the voltage level of which at an output can be higher, lower, inverted, or insulated with respect to the supplied DC voltage.

An overcurrent protection device is also known as a DC breaker and serves to interrupt an electrical circuit when the electrical current therein exceeds a fixed current strength, in particular over a specified time. Such overcurrent protection devices can, for example, be designed as a fuse or as a miniature circuit breaker.

In particular, both the DC/DC voltage converter and the overcurrent protection device can each be arranged on a separate printed circuit board. It should be noted at this point that a printed circuit board (PCB) is generally a support element for electronic elements, which is in particular used for mechanical fastening and electrical connection among said elements. Electronic elements are in this case used to regulate and monitor the electrical current. For this purpose, printed circuit boards comprise an electrically insulating material on which or in which further electrically conductive connections (referred to as conductor tracks, which are preferably made of copper) are arranged. In particular, the electronic elements are connected to the printed circuit board in a bonded manner, e.g. particularly preferably soldered, so that an electrically conductive connection is also formed with the conductor tracks.

These electronic components, for example the DC/DC voltage converter or the overcurrent protection device, can each further comprise a plurality of individual switching devices. In this case, a switching device is in principle used in order to switch a circuit so that the latter is either open or closed. These switching devices can be designed, for example, as a semiconductor switch, which is also referred to as a transistor, a power metal oxide semiconductor field-effect transistor (abbreviated as MOSFET), or an insulated gate bipolar transistor (abbreviated as IGBT). In addition, the switching device can, e.g., in this case also be designed as a relay, which is in principle a switch operated by an electrical current and generally having two switch positions, and in which an electrical contact can, e.g., be opened and closed by an electromagnetic force. In particular, such switching devices are arranged in groups and at different locations. It should be noted at this point that the first element of a battery controller and the second element of a battery controller can each comprise a plurality of individual switching devices.

Such switching devices heat up, in particular during operation of the battery, and must therefore be cooled. As a result, a plurality of regions are formed, which are exposed to different heating systems and thus have different cooling specifications.

It should be noted at this point that, for example, a DC/DC voltage converter and an overcurrent protection device also have different cooling specifications. Overall, a housing element of the battery according to the invention can be used to provide cooling which can meet the various requirements previously described in an optimized manner.

It is particularly advantageous for the first temperature-control structure to comprise a plurality of first flow interference elements, and for the second temperature-control structure to comprise a plurality of second flow interference elements. Differently designed regions have different arrangement densities, different diameters, and/or different heights of the first flow interference elements and/or the second flow interference elements. In this context, an arrangement density describes the number of first flow interference elements or second flow interference elements within a certain area. It should be noted at this point that flow interference elements are designed both to increase a heat-transferring surface and to increase heat transfer. In particular, flow interference elements serve to interfere with the flow of the flowing temperature-control fluid and thereby increase the turbulence of the flowing temperature-control fluid and thus, in particular, enable a transition from a laminar flow to a turbulent flow, which can significantly increase the heat transfer.

In particular, the first flow interference elements and the second flow interference elements each have a circular cross-sectional region. Preferably, the first flow interference elements and the second flow interference elements can be arranged offset to each other.

Particularly preferably, the housing element is designed as a die-cast housing. The cover element is in particular also designed as a die-cast component. In particular, the first flow interference elements and the second flow interference elements can be formed during the respective die-casting process.

It is advantageous if both a component of the first element of a battery controller and a component of the second element of a battery controller are arranged in a first region, and if, furthermore, first interference elements are formed on the housing element and second interference elements are formed on the cover element. It should be noted at this point that a component can, for example, comprise a switching device, such as a MOSFET in particular. In other words, components or parts of the battery controller being temperature-controlled are arranged on both sides of the flow chamber in the first region and can, therefore, also be reliably cooled. In particular, the respective identically designed first heights of the first flow interference elements and the respective identically designed second heights of the second flow interference elements are identical to each other. As a result, a symmetrical design is able to be provided. Furthermore, it is also possible that the respective identically designed first heights of the first flow interference elements are different from the respective identically designed second heights of the second flow interference elements. As a result, an asymmetrical design is able to be provided. Such an asymmetrical design offers the advantage that different temperature control requirements can be met in an optimized way. In particular, a higher temperature control requirement can be met with a greater height compared to a lower height for a lower temperature control requirement. Furthermore, the first flow interference elements and the second flow interference elements should be at a distance from one another so that a uniform flow of the temperature-control fluid is enabled.

It is also advantageous if only one component of the first element of a battery controller is arranged in a second region and if, furthermore, first flow interference elements are only formed on the housing element. It is also advantageous if only one component of the second element of a battery controller is arranged in the second region and if second flow interference elements are only formed on the cover element. It should be noted at this point that a component can, for example, comprise a switching device, such as a MOSFET in particular. In other words, components or parts of the battery controller being temperature-controlled in the second region are arranged on one side of the flow chamber and can therefore also be reliably cooled. In particular, it should be noted at this point that the housing element of the battery can comprise a plurality of second regions if, for example, components of the first element of a battery controller and components of the second element of the battery controller are arranged alternately. For the sake of completeness, it should also be noted that, on the opposite side, the cover element does not form any second flow interference elements, and the housing element does not form any first flow interference elements.

Overall, an embodiment of the housing element of the battery according to the present invention offers the advantage that, by means of uniform flow guidance, a pressure drop can be minimized, heat transmission can be consistent, and homogeneous, improved deaeration can also be provided.

The object of the present invention is also a battery comprising a housing element, as described hereinabove. The housing element is in this case connected to a further housing element, while forming an interior space. A plurality of battery cells are in this case accommodated within the interior space.

### BRIEF DESCRIPTION OF THE DRAWINGS

Exemplary embodiments of the invention are shown in the drawings and explained in more detail in the following description.

Shown are:

FIG. 1 a perspective view of the upper side of one embodiment of a housing element according to the invention,

FIG. 2 a perspective view of an underside of an embodiment of a housing element according to the invention

FIG. 3 a perspective view of a section of an embodiment of a housing element according to the invention, showing a cover element,

FIG. 4 a perspective view of a section of one embodiment of a housing element according to the invention without a representation of the cover element,

FIG. 5 an associated cover element,

FIG. 6 a flow guide within a flow chamber,

FIG. 7 a first sectional view of an embodiment of a battery according to the invention,

FIG. 8 a second sectional view of one embodiment of a battery according to the invention, and

FIG. 9 a representation of flow interference elements.

### DETAILED DESCRIPTION

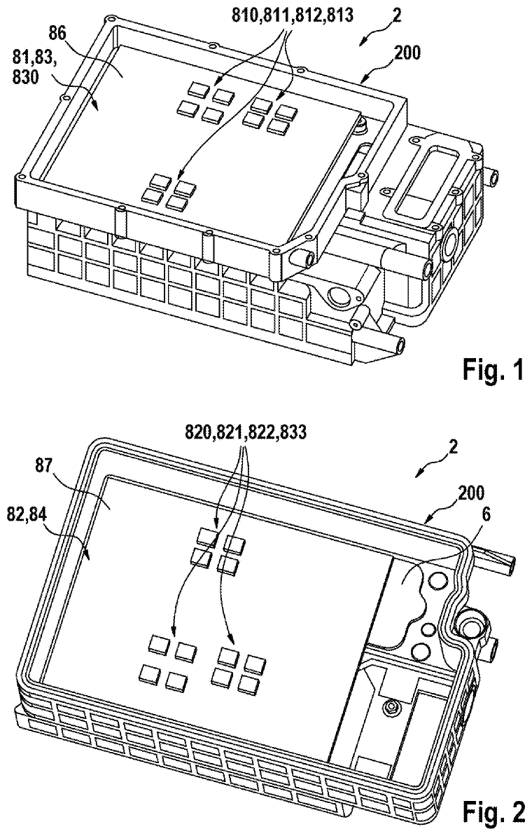

FIG. 1 shows a perspective view of an upper side of an embodiment of a housing element 2 of a battery 1 according to the invention, and FIG. 2 shows a perspective view of an underside of an embodiment of a housing element 2 of a battery 1 according to the invention.

The housing element 2 of the battery 1 shown in FIGS. 1 and 2 is designed to be connected to a further housing element 3, said elements providing a commonly formed interior space 4 for accommodating a plurality of battery cells 20. A plurality of battery cells 20 can thereby be accommodated within the interior space 4. According to the exemplary embodiment of the invention shown in FIG. 1 and FIG. 2, the housing element 2 of the battery 1 is designed as a die-cast housing 200.

FIG. 1 shows a first element 81 of a battery controller. In particular, the first element 81 of a battery controller is designed as an electrical voltage converter 83, and preferably as a DC/DC converter 830. The first element 81 of a battery controller further comprises a first printed circuit board 86, on which components 811, 812, 813 of the first element 81 of a battery controller (e.g., switching devices 810 designed in particular as MOSFETs) are arranged. The first element 81 of a battery controller is arranged on the housing element 2 in a thermally conductive manner.

FIG. 2 shows a second element 82 of a battery controller. In particular, the second element 82 of a battery controller is in this case designed as an overcurrent protection device 84. The second element 82 of a battery controller further comprises a second printed circuit board 87, on which components 821, 822, 823 of the second element 82 of a battery controller (e.g., switching devices 820 designed in particular as MOSFETs) are arranged. FIG. 2 also shows a cover element 6, which is connected to the housing element 1. The second element 82 of a battery controller is arranged on the cover element 6 in a thermally conductive manner.

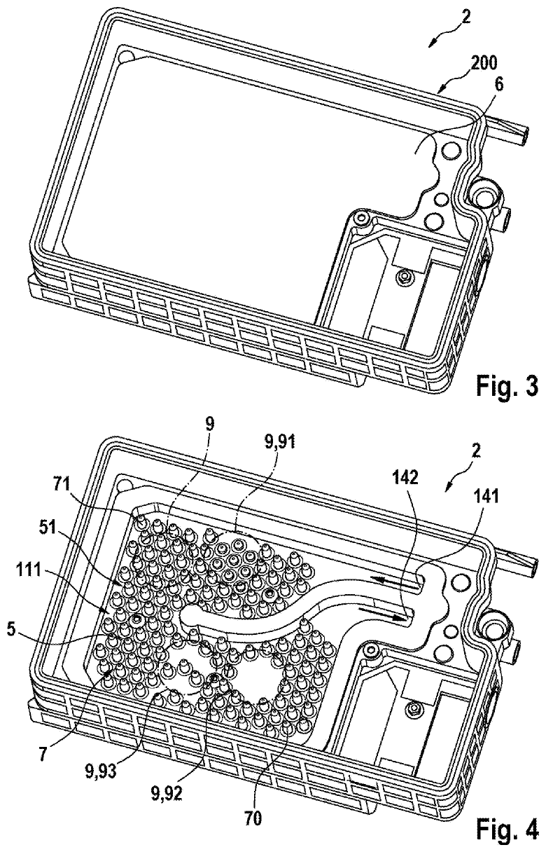

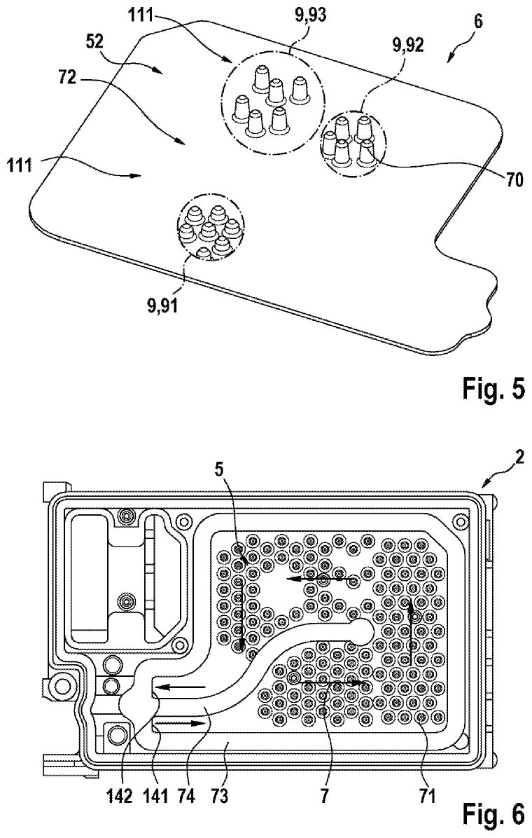

FIG. 3 shows a perspective view of a section of an embodiment of a housing element 2 according to the invention with a representation of a cover element 6, and FIG. 4 shows a perspective view of a section of an embodiment of a housing element 2 according to the invention without a representation of the cover element 6. FIG. 5 also shows the associated cover element 6.

FIG. 4 initially shows that the housing element 2 forms a first temperature-control structure 51.

FIG. 5 shows that the cover element 6 forms a second temperature-control structure 52.

The housing element 2 and the cover element 6 can be connected to each other such that a flow chamber 5, which can be seen in FIG. 4, is formed. The temperature-control fluid 7 can flow through this flow chamber 5.

Furthermore, the first temperature-control structure 51 and the second temperature-control structure 52 are arranged within the flow chamber 5 and are arranged so that the temperature-control fluid 7 can flow around them.

In particular, it should be noted at this point that the first element 81 of a battery controller is arranged directly adjacent to the first temperature-control structure 51, and that the second element 82 of a battery controller is arranged directly adjacent to the second temperature-control structure 52. In particular, the first element 81 of a battery controller is arranged on a side of the housing element 2 facing away from the cover element 6, and the second element 82 of a battery controller is arranged on a side of the cover element 6 facing the interior space 4.

It can also be seen that the flow chamber 5 comprises a plurality of regions 9. In these regions 9, the first temperature-control structure 51 and/or the second temperature-control structure 52 are each designed differently.

The first temperature-control structure 51 comprises a plurality of first flow interference elements 71, and the second temperature-control structure 52 comprises a plurality of second flow interference elements 72.

As can be seen from FIGS. 4 and 5, differently designed regions 9 have a different arrangement density 111 in the first flow interference elements 71 and the second flow interference elements 72.

For example, the housing element 2 and the cover element 6 comprise a first region 91, in which one component 811 of the first element 81 of a battery controller and one component 821 of the second element 82 of a battery controller are arranged. First flow interference elements 71 are in this case formed on the housing element 2, and second flow interference elements 72 are formed on the cover element 6. In particular, the first flow interference elements 71 and the second flow interference elements 72 have a circular cross-sectional area 70.

For example, the housing element 2 and the cover element 6 comprise a second region 92, in which only one component 812 of the second element 82 of a battery controller is arranged and only second flow interference elements 72 are arranged on the cover element 6. As can be seen in FIG. 4, the housing element 2 has no first flow interference elements 71. Of course, it is also possible to form a second region 92, in which only one component 812 of the first element 81 of a battery controller is arranged and only first flow interference elements 71 are formed on the housing element 2. Furthermore, the cover element 6 would not have second flow interference elements 72.

It can also be seen that the housing element 2 and the cover element 6 can comprise a third region 93. Both a component 813 of the first element 81 of a battery controller and a component 823 of the second element 82 of a battery controller are in this case arranged in the third region 93. The component 813 and the component 823 are arranged offset to each other. In other words, the third region 93 differs from the first region 91 and the second region 92 in that, in the third region 93, component 813 and component 823 are arranged offset to each other and that, in the first region 91 and in the second region 92, component 811 and component 821, or rather component 812 and component 822, are arranged opposite to each other. Furthermore, in the third region 93, first flow interference elements 71 are arranged on the housing element 2 and second flow interference elements 72 are arranged on the cover element 6, which are also arranged offset to one another and can preferably engage with one another.

FIG. 4 also shows that the housing element 2 also has an inlet 141, which is designed to let temperature-control fluid 7 into the flow chamber 5, and that the housing element 2 also has an outlet 142, which is designed to let temperature-control fluid 7 out of the flow chamber 5.

FIG. 6 shows a flow guide within a flow chamber 5. The flow guide thereby forms a U-shaped profile. In particular, the housing element 2 comprises flow guide elements 73, which serve to delimit the flow chamber 5. The housing element 2 further comprises an intermediate element 74, which is designed to prevent a short-circuit flow between the inlet 141 and the outlet 142.

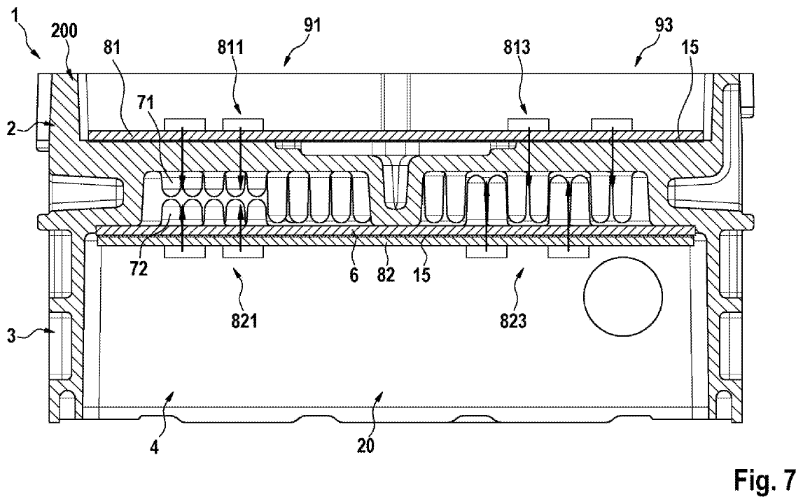

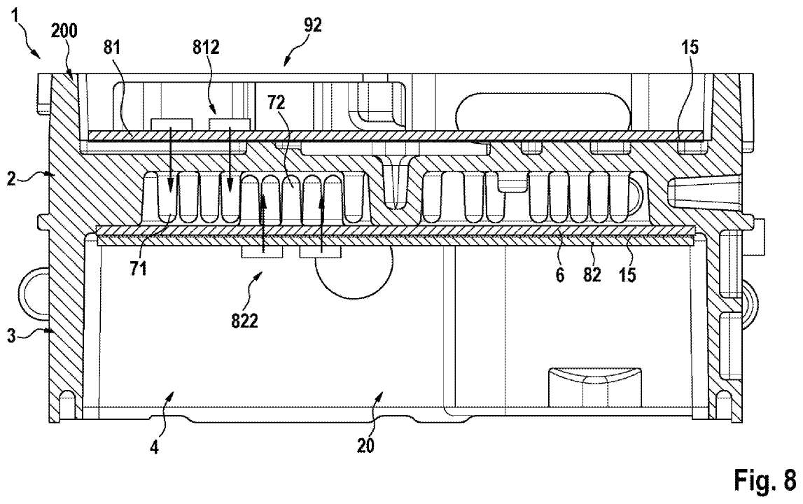

FIG. 7 shows a first sectional view of one embodiment of a battery 1 according to the invention, and FIG. 8 shows a second sectional view of one embodiment of a battery 1 according to the invention.

The first housing element 2 and the further housing element 3 can be seen and are connected to each other while forming the interior space 4, in which a plurality of battery cells 20 are accommodated.

A thermal compensation material 15 can also be seen, which serves to improve heat conduction.

FIG. 7 also shows a first region 91, in which one component 811 of the first element 81 of a battery controller and one component 821 of the second element 82 of a battery controller are arranged. Furthermore, first flow interference elements 71 are formed on the housing element 2, and second flow interference elements 72 are formed on the cover element 6.

FIG. 8 also shows two second regions 92, in each of which only one component 812 of the first element 81 of a battery controller is arranged, or in which only one component 822 of the second element 82 of a battery controller is arranged. Furthermore, only first flow interference elements 71 are formed on the housing element 2, or only second flow interference elements 72 are formed on the cover element 6.

Furthermore, a third region 93 can also be seen in FIG. 7, in which one component 813 of the first element 81 of a battery controller and one component 823 of the second element 82 of a battery controller are arranged, whereby the components 813 and the components 823 are arranged offset to one another. Furthermore, first flow interference elements 71 are formed on the housing element 2 and second flow interference elements 72 are formed on the cover element 6, whereby the first flow interference elements 71 and the second flow interference elements 72 are arranged offset to one another.

FIGS. 7 and 8 show the optimized thermal paths between the first element 81 of a battery controller and the temperature-control fluid 7 and between the second element 82 of a battery controller and the temperature-control fluid 7.

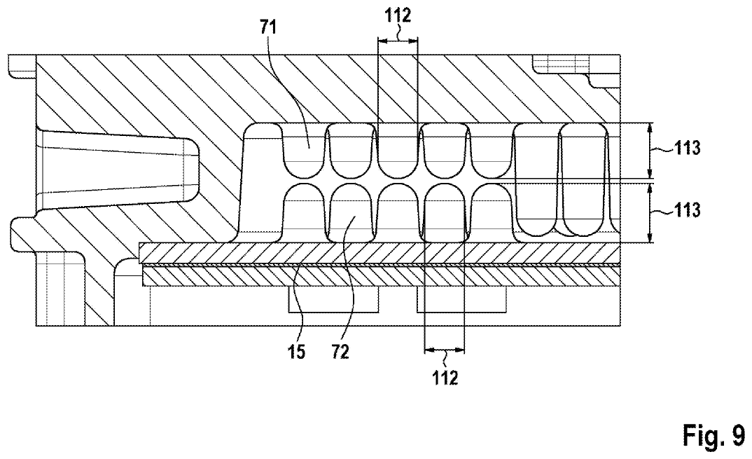

FIG. 9 shows a representation of flow interference elements. In particular, first flow interference elements 71 and second flow interference elements 72 can be seen, which each have a diameter 112 and a height 113. It should be noted at this point that in the first region 91, the second region 92 and the third region 93, the diameters 112 and/or the heights 113, as well as the arrangement density 111, can also have a different design.

1. A housing element of a battery (1), wherein the housing element (2) is configured to be connected to an additional housing element (3), said elements providing a commonly formed interior space (4) for accommodating a plurality of battery cells (20), wherein the housing element (2) forms a first temperature-control structure (51), and a cover element (6) that forms a second temperature-control structure (52) is connected to the housing element (2) such that a flow chamber (5), through which temperature-control fluid (7) can flow, is delimited in a fluid-tight manner, wherein the first temperature-control structure (51) and the second temperature-control structure (52) are arranged inside the flow chamber (5) and are arranged so that temperature-control fluid (7) can flow around them, wherein a first element (81) of a battery controller is arranged in a thermally conductive manner on the housing element (2), and a second element (82) of a battery controller is arranged in a thermally conductive manner on the cover element (6), wherein the flow chamber (5) comprises a plurality of regions (9), whereby the first temperature-control structure (51) and/or the second temperature-control structure (52) each have a different design.

2. The housing element according to claim 1, wherein the first element (81) of a battery controller is arranged directly adjacent to the first temperature-control structure (51), and the second element (82) of a battery controller is arranged directly adjacent to the second temperature-control structure (52).

3. The housing element according to claim 1, wherein the first element (81) of a battery controller is an electrical voltage converter (83), and/or wherein the second element (82) of a battery controller is an overcurrent protection device (84).

4. The housing element according to claim 1, wherein the first temperature-control structure (51) comprises a plurality of first flow interference elements (71), and wherein the second temperature-control structure (52) comprises a plurality of second flow interference elements (72), wherein differently designed regions (9) each have different arrangement densities (111), different diameters (112), and/or different heights (113) of the first flow interference elements (71) and/or the second flow interference elements (72).

5. The housing element according to claim 4, wherein the first flow interference elements (71) and the second flow interference elements (72) each have a circular cross-sectional area (70).

6. The housing element according to claim 1, wherein the housing element (2) is configured as a die-cast housing (200).

7. The housing element according to claim 4, wherein a component (811) of the first element (81) of a battery controller and a component (821) of the second element (82) of a battery controller are arranged in a first region (91), wherein first flow interference elements (71) are formed on the housing element (2), and second flow interference elements (72) are formed on the cover element (6).

8. The housing element according to claim 4, wherein only one component (812) of the first element (81) of a battery controller is arranged in a second region (92), and only first flow interference elements (71) are formed on the housing element (2), or in thatwherein only one component (822) of the second element (82) of a battery controller is arranged, and only second flow interference elements (72) are formed, on the cover element (6).

9. The housing element according to claim 1, wherein the housing element (2) further comprises an inlet (141) configured for an inflow of temperature-control fluid (7) into the flow chamber (5) and an outlet (142) configured for an outflow of temperature-control fluid (7) out of the flow chamber (5).

10. A battery comprising a housing element according to claim 1, wherein the housing element is connected to an additional housing element (3) so as to form an interior space (4), and a plurality of battery cells (20) is accommodated within the interior space (4).

11. The housing element according to claim 2, wherein the first element (81) of a battery controller is arranged on a side of the housing element (2) facing away from the cover element (6), and wherein the second element (82) of a battery controller is arranged on a side of the cover element (6) facing the interior space (4).

12. The housing element according to claim 3, wherein the electrical voltage converter (83) is a DC/DC converter (830).
